(19) United States
(12) Patent Application Publication
(10) Pub. No.: US 2015/0335033 A1
(43) Pub. Date: Nov. 26, 2015

(54) METHOD OF INCREASING BIOACTIVE COMPOUNDS IN A PLANT

(71) Applicant: UNIVERSITY OF THE WESTERN CAPE, Cape Town (ZA)

(72) Inventor: Jeremy Klaasen, Cape Town (ZA)

(21) Appl. No.: 14/414,318

(22) PCT Filed: Jul. 13, 2013
(86) PCT No.: PCT/IB2013/055822

§ 371 Date: Jan. 12, 2015

(30) Foreign Application Priority Data
Jul. 13, 2012 (ZA) 2012/05221

(51) Int. Cl. A01N 65/08; A01N 47/14; A01N 65/36; A01N 43/653; A01N 59/20; A01N 59/00; A01N 59/14

(52) U.S. Cl. CPC A01N 65/08; A01N 59/00; A01N 47/14; A01N 59/14; A01N 43/653; A01N 59/20; A01N 65/36

(57) ABSTRACT

This invention relates to a method of increasing bioactive compounds in a plant. In particular, the invention relates to increasing the polyphenolic and/or total soluble solids content in a plant by administration of an extract of Galenia africana to the plant.

### BACKGROUND OF THE INVENTION

This invention relates to a method of increasing the polyphenolic and/or total soluble solids content in a plant.

As society moves towards becoming “greener”, more emphasis is placed on healthy living, for example people are encouraged to increase the amount of fruits and vegetables in their diet. Epidemiological studies carried out have indicated a positive correlation between the intake of fruits and vegetables and reduced rate of heart disease mortalities, common cancers, and other degenerative diseases as well as aging.

In general, the bioactive compounds present in fruits and vegetables are what play a role in preventing diseases. These bioactive compounds, or phenolic compounds, are a class of higher plant secondary metabolites (Dillard et al., 2000). The polyphenolic compounds that are common to food materials fall into three groups, namely, simple phenols and phenolic acids, hydroxycinnamic acid derivatives and flavonoids.

Of those mentioned above, the flavonoids are the single most important group of polyphenolics, consisting mainly of catechins, proanthocyanins, anthocyanidins and flavons, flavonols and their glycosides (Huang et al., 1991). The most important groups of phenolics in food are flavanones, chalcones and dihydrochalcones flavonoids. Major dietary sources of flavanones and dihydrochalcones are citrus fruits and apples respectively.

The flavonoids are known to possess several beneficial properties such as antioxidant, antibacterial, antiviral, anti-inflammatory, antimutagenic and antitumoral activity, as well as the activation or inactivation of certain enzymes (Rice-Evans & Packer, 1998). Yet, their toxicity to animal cells is low. Flavonoids are phytonutrients that are responsible for the vibrant purple colour of grapes, grape juice and red wine; the stronger the colour, the higher the concentration of flavonoids. These flavonoid compounds include quercitin, as well as a second flavonoid-type compound (which falls into the chemical category of stilbenes) called resveratrol. Due to their proven ability to inhibit specific enzymes, to stimulate some hormones and neuro-transmitters, and to scavenge free radicals, modern physicians are increasing their use of pure flavonoids to treat many important common diseases.

The total soluble solids (TSS) content of a solution is determined by the index of refraction. This is measured using a refractometer, and is referred to as the degrees Brix. It is widely used during fruit and vegetable processing to determine the concentration of sugar in the products.

TSS and yield when processing plants such as tomatoes are influenced by a number of factors including genetics, the growing environment and management practices. Translocation of assimilates (a major constituent of TSS) within plant parts is also known to be affected by growing conditions and plant age. ° Brix, which has been commonly used for expressing the juice quality of the so-called table citrus, has been frequently used also for expressing the juice quality of acid citrus.

A small increase in the ° Brix percentage can make a large difference to the commercial value of the fruit or vegetable which is why fresh produce companies base their harvesting on the Brix levels of the produce. Processing companies also base their payment for produce on the ° Brix. For example, a processing company purchasing tomatoes may pay the farmer 10% less for produce with a ° Brix of 4.5% compared to a ° Brix of 4.6%. In addition, a higher Brix level in the fruit will allow a producer to access markets earlier in a given season.

It would therefore be useful to have a method of increasing the levels of polyphenolics and ° Brix in plants, in particular in food crops.

### SUMMARY OF THE INVENTION

According to a first embodiment of the invention, there is provided the use of a Galenia africana extract for increasing the polyphenolic compound content in a plant.

The polyphenolic compound may be a bioactive compound that has a positive effect on human health. In particular, the polyphenolic compound may be a cholesterol-lowering agent, an antioxidant, a radical scavenger, an anti-inflammatory agent, a carbohydrate metabolism promoter, or an immune system modulator, an anti-ulcer agent, an oestrogen antagonist or may modulate the metabolism of a xenobiotic.

For example the polyphenolic compound may be a flavone, a hydroxycinnamic acid, a flavonol, a hydroxybenzoic acid, a flavonol or chatechin, or a flavanone. More particularly, the polyphenolic compound is naringenin, chlorogenic acid or 7-hydroxyflavanone, 5.7-dihydroxyflavonone (Pinocembrin).

According to a second embodiment of the invention, there is provided the use of a Galenia africana extract for increasing the total soluble solids content in a plant. Typically, the plant is a food plant such as a tomato, apple, pear, peach or grape plant.

According to a further embodiment of the invention, there is provided a use of a Galenia africana extract for increasing the polyphenolic compound content in a plant to which a fungicide has been, or is administered.

According to a further embodiment of the invention, there is provided a use of a Galenia africana extract for increasing the total soluble solids content in a plant to which a fungicide has been, or is administered.

The administration of the fungicide may be before, after or simultaneously with the administration of the Galenia africana extract.

According to a further embodiment of the invention, there is provided a method of increasing the content of polyphenolic compounds in a plant, wherein the method comprises administration of an extract of Galenia africana to the plant.

According to a further embodiment of the invention, there is provided a method of increasing the content of total soluble solids in a plant, wherein the method comprises administration of an extract of Galenia africana to the plant.

According to a further embodiment of the invention, there is provided a method of increasing the content of polyphenolic compounds in a plant to which a fungicide has been, or is administered, wherein the method comprises administration of an extract of Galenia africana to the plant.

According to a further embodiment of the invention, there is provided a method of increasing the content of total soluble solids in a plant to which a fungicide has been, or is, administered, wherein the method comprises administration of an extract of Galenia africana to the plant.

The Galenia africana extract may be administered at an amount of about 0.25% to about 2% (v/v).

The fungicide may be selected from the group consisting of Sodium Bicarbonate, Boric acid/citrus oil, Mancozeb, Sulphur, Penconazole, Fusilasole, Copperoxide, Kresoxim methyl (or Strobulirin) and Triazole.

According to a further embodiment of the invention there is provided a plant, or a leaf, tuber or fruit thereof with increased polyphenolic compound content relative to an untreated plant, wherein the plant, or leaf, tuber or fruit thereof with increased polyphenolic compound content has been treated with an extract of Galenia africana.

According to a further embodiment of the invention there is provided a plant, or a leaf, tuber or fruit thereof with increased total soluble solids content relative to an untreated plant, wherein the plant, or leaf, tuber or fruit thereof with increased total soluble solids content has been treated with an extract of Galenia africana.

According to a further embodiment of the invention there is provided a plant, or a leaf, tuber or fruit thereof with increased polyphenolic compound content, wherein the plant, or leaf, tuber or fruit thereof has been, or is treated with a fungicide and an extract of Galenia africana, compared to a plant, or leaf, tuber or fruit thereof treated with a fungicide alone.

According to a further embodiment of the invention there is provided a plant, or a leaf, tuber or fruit thereof with increased total soluble solids content, wherein the plant, or leaf, tuber or fruit thereof has been, or is treated with a fungicide and an extract of Galenia africana, compared to a plant, or leaf, tuber or fruit thereof treated with a fungicide alone.

According to a further embodiment of the invention is provided a kit for increasing the polyphenolic compound content in a plant, comprising an effective dose of an extract of Galenia africana and instructions for use. According to a further embodiment of the invention is provided a kit for increasing the total soluble solids content in a plant, comprising an effective dose of an extract of Galenia africana and instructions for use.

### BRIEF DESCRIPTION OF THE DRAWINGS

FIG. 1 shows the total polyphenolics content for tomato fruit as mg Gallic acid equivalent/100 g dry (A) or fresh (B) weight, after administration of antifungal agents with or without G. africana extract in comparison to the control, untreated plants (T1);

FIG. 2 shows the naringerin (A) or chlorogenic acid (B) flavonoid content for tomato fruit (μg/g dry weight) after administration of antifungal agents with or without G. africana extract in comparison to the control, untreated plants (T1);

FIG. 3 shows the total polyphenolics content for table grape fruits as mg Gallic acid equivalent/100 g dry weight, after administration of varying doses of antifungal agents with or without G. africana extract in comparison to the control, untreated plants (T1);

FIG. 4 shows the total polyphenolics content for apple fruits as mg Gallic add equivalent/100 g dry weight, after administration of varying doses of antifungal agents with or without G. africana extract in comparison to the control, untreated plants (T1);

FIG. 5 shows the Total Soluble Solids (TSS) content for apple fruits as Brix %, after administration of varying doses of antifungal agents with or without different concentrations of G. africana extracts in comparison to the control, untreated plants (T1);

FIG. 6 shows the Total Soluble Solids (TSS) content for pear fruits as Brix %, after administration of varying doses of antifungal agents with or without different concentrations of G. africana extracts in comparison to the control, untreated plants (T1);

FIG. 7 shows the total polyphenolics content for peach fruits as mg Gallic acid equivalent/100 g dry weight, after administration of varying doses of antifungal agents with or without G. africana extract in comparison to the control, untreated plants (T1); and

FIG. 8 shows the Total Soluble Solids (TSS) content for peach fruits an two farms (A and B) as Brix %, after administration of varying doses of antifungal agents with or without G. africana extract in comparison to the control, untreated plants (T1).

### DETAILED DESCRIPTION OF THE INVENTION

This invention provides a method of increasing the polyphenolics and/or total soluble solids content in a plant.

G. africana (also known as kraalbos) is a plant which is widely distributed on dry flats and lower slopes occurring in South Africa from the Northern Cape and Namaqualand to Uniondale, the Karoo and Eastern Cape Province. The plant is known to cause a disease in sheep and goats, known as ‘water guts’ or colloquially as ‘waterpens’. Namaqualand livestock and wheat farmers consider kraalbos to be a useless problem plant that invades large land areas after stopping wheat production.

It has previously been shown that extracts from G. africana are effective against bacterial species, S. aureus and a Penicillium in laboratory studies either alone or acting in synergy with Sodium Bicarbonate. Furthermore, a composition of extracts from G. africana has been shown to synergistically enhance the efficacy of fungicides against economically important phytopathogenic fungi for the horticultural industry. In these studies, a half-dosage of the fungicide was as efficient when administered together with the G. africana extract as the full dosage of fungicide alone.

The applicant has now surprisingly shown that the levels of polyphenolic compounds and total soluble solids (TSS) in a plant can be increased by application of an extract of G. africana to a plant. In particular, the applicant has shown that an antifungal composition comprising an antifungal agent and an extract of G. africana increases the levels of polyphenolic compounds and TSS in a treated plant relative to a plant treated with the antifungal agent alone. Typically, the fungicide would be Sodium Bicarbonate, Borax/Citrus oil, Mancozeb, Sulphur, Penconazole, Fusilasole, Copperoxide, Kresoxim methyl (or Strobulirin), or Triazole.

Examples of polyphenolic compounds which have increased levels due to administration of an extract of G. africana are naringenin and chlorogenic acid.

Naringenin is a flavanone that is considered to have a bioactive effect on human health as a cholesterol-lowering agent, antioxidant, radical scavenger, anti-inflammatory agent, carbohydrate metabolism promoter, and immune system modulator. It works as an anti-ulcer agent and oestrogen antagonist which inhibits the action or biosynthesis of oestrogenic compounds. Naringin is the aglycone of naringenin. Naringin is known as an antioxidant in the body. Naringenin is also known to indirectly modulate the metabolism of many xenobiotics. It is one of the most abundant polyphenols in tomato.

Chlorogenic acid is a polyphenolic compound that occurs in fruits and vegetables such as tomatoes strawberries, pineapples, green peppers and carrots and is known to remove nitric acids from cells before they can bond to amines, thereby inhibiting nitrosamine carcinogens from forming.

The Galenia africana extract is optimally administered by in a spray treatment, preferably with a backpack sprayer or a high pressure tank sprayer. The extract is typically administered to the plant once every one to four weeks, although optimal administration is once every one to two weeks. The extract is optimally administered at a concentration of 1% (v/v), although a range of concentration from 0.25% to 2% is also effective.

The invention is further described by the following examples, which are not to be construed as limiting in any way either the spirit or scope of the invention.

### EXAMPLES

A number of field trials were performed in order to demonstrate the effect of administration of a G. africana extract to plants such as tomatoes, apples, pears, grapes, and peaches either in a composition together with various fungicides, or alone.

The total polyphenolic, flavonoid and total soluble solids content were analysed.

In each case the administration of a G. africana extract increased the level of total polyphenolic compounds and total soluble solids content compared to when no G. africana extract was added.

1. Methods

1.1. Preparation of Active Plant Extract from Galenia africana

Fresh green leaves and shoots of G. africana were harvested and dried on farms in the Namakwa District of the Northern Cape Province, South Africa. The dried plant material was put through a hammer mill to yield a powdery material between 2-3 mm. A 20% (w/v) plant tincture was macerated by mixing the milled plant material in a shaker for 12 hours maximum with 80.0% ethanol as solvent. The 20% (w/v) G. africana extract tincture was decanted, filtered and stored at room temperature until used.

1.2. Total Polyphenolic Analysis

Total polyphenolic analyses were determined using the method as described by Singleton et al., 1999.

1.3. Flavonoid Analysis

Sample preparation: 200 mg freeze dried sample hydrolysed for 30 minutes at 35° C. in a 15 ml aqueous solution containing 2N NaOH, 15 mg ascorbic acid and 5 mg EDTA. Chlorogenic acid and naringenin extracted from this solution (saturated with NaCl) with ethyl acetate after adjusting pH to 2.0 with 5N hydrochloric acid. The ethyl acetate was dried under a nitrogen stream and the residue re-dissolved in methanol for HPLC analysis.

1.4. Total Soluble Solids Analysis

Sample preparation: 18 fruits were collected per tree per rep for each treatment. There were four random replications. In total 72 fruits was used for each treatment. Fruits were blended to obtain a juice. Total soluble solids (%) were then measured with a digital refractometer (Atago PR-32 α (0-32%)) on the juice of a composite sample for each treatment.

### Example 1

A field trial was laid out to test the efficacy of the fungicide products in combination with a G. africana extract on tomatoes (cultivar—Rosalina) at a farm in Paarl in the Western Cape region.

| | PRODUCTS | VOLUME/100 L |
|---|---|---|
| T. 1 | Control (Untreated) | |
| T. 2 | Full-dose Mancozeb | 200 g |
| T. 3 | Half-dose Sodium Bicarbonate + G. africana | 750 g + 5 L |
| | (20% w/v) | |
| T. 4 | Half-dose Borax/Citrus oil + G. africana | 250 ml + 5 L |
| | (20% w/v) | |

Plants were sprayed with a pressure sprayer in accordance with the application regimen indicated below.

APPLICATION DATE

| | 10 Aug. | 18 Aug. | 1 Sep. | 14 Sep. | 4 Oct. |
|---|---|---|---|---|---|
| | 2009 | 2009 | 2009 | 2009 | 2009 |
| BEGIN | 14 H 00 | 14 H 15 | 15 H 00 | 11 H 00 | 9 H 00 |
| TIME | | | | | |
| END | 15 H 45 | 16 H 15 | 16 H 45 | 13 H 00 | 11 H 30 |
| TIME | | | | | |

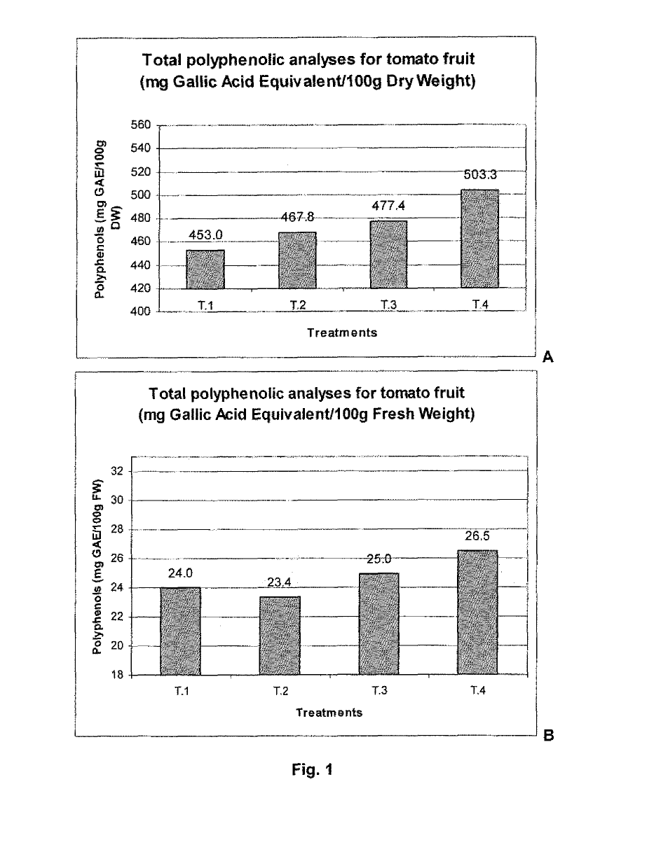

FIGS. 1 A and B shows that an application to tomato plants of a composition comprising a half-dosage of Sodium Bicarbonate or Borax/Citrus oil fungicide and a G. africana extract (T3, T4) increases the total polyphenolic levels compared to a full-dosage fungicide treatment with Mancozeb (T2) or to the untreated control. All four treatments were replicated four times and the figure above each column indicates the mean of the four replicates.

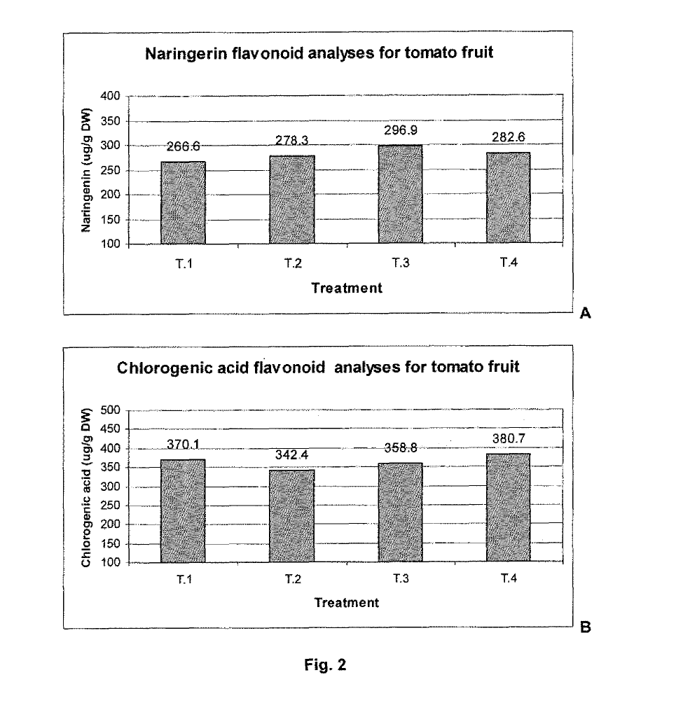

Furthermore, FIG. 2 A shows that an application to tomato plants of a composition comprising a half-dosage of Sodium Bicarbonate or Borax/Citrus oil fungicide and a G. africana extract (T3, T4) increases the total Naringerin flavonoid levels compared to a full-dosage fungicide treatment with Mancozeb (T2) or to the control. In addition FIG. 2 B shows that an application of a composition comprising a half-dosage of Sodium Bicarbonate or Borax/Citrus oil fungicide and a G. africana extract (T3, T4) increases the total Chlorogenic acid flavonoid levels compared to a full-dosage fungicide treatment with Mancozeb (T2). The composition comprising a half-dosage of Borax/Citrus oil fungicide and G. africana extract (T4) was also able to increase the levels of Chlorogenic acid flavonoid compared to the control.

### Example 2

A field trial was laid out to test the efficacy of fungicide products (Borax/Citrus oil, Sulphur, Penconazole, Fusilasole, Copperoxide and Mancozeb) in a program in combination with G. africana extract on sultanas (cultivar—Seedless Thompsen) at Worcester in the Western Cape region. The G. africana extract was at a concentration of 20% (w/v).

| | |
|---|---|
| PRODUCTS | VOLUME/100 L |

APPLICATION DATE: 20 Oct. 2009

| | | |
|---|---|---|
| 1. | Control (Untreated) | |
| 2. | Mancozeb + Ammonium phosphite + | 200 g + 400 ml + 22.5 g |
| | Penconazole R | |
| 3. | Boric acid/citrus oil | 500 ml |
| 4. | Mancozeb + Ammonium phosphite + | 100 g + 200 ml + 11.25 g + |
| | Penconazole + G. africana extract. | 5 L |
| 5. | Boric acid/citrus oil + G. africana | 250 ml + 5 L |
| | extract | |

APPLICATION DATE: 30 Oct. 200

| | | |
|---|---|---|
| 1. | Control (Untreated) | |
| 2. | Mancozeb + Ammonium phosphite + | 200 g + 400 ml + 40 ml |
| | Fusilasole | |
| 3. | Boric acid/citrus oil + Ammonium | 500 g + 400 ml |
| | phosphite | |
| 4. | Mancozeb + Ammonium phosphite + | 100 g + 200 ml + 20 ml + |
| | Fusilasole + G. africana extract | 5 L |
| 5. | Boric acid/citrus oil + G. africana | 250 ML + 5 L |
| | extract | |

APPLICATION DATE: 16 Nov. 2009

| | | |
|---|---|---|
| 1. | Control (Untreated) | |
| 2. | Mancozeb + Ammonium phosphite + | 200 g + 400 ml + 40 ml |
| | Fusilasole | |
| 3. | Boric acid/citrus oil + Ammonium | 500 ml + 400 ml |
| | phosphite. | |
| 4. | Mancozeb + Ammonium phosphite + | 100 g + 200 ml + 20 ml + |
| | Fusilasole + G. africana extract | 5 L |
| 5. | Boric acid/citrus oil + G. africana | 250 ml + 5 L |
| | extract | |

APPLICATION DATE: 26 Nov. 2009

| | | |
|---|---|---|
| 1. | Control (Untreated) | |
| 2. | Copperoxide + Fusilasole | 180 g + 40 ml |
| 3. | Boric acid/citrus oil | 500 ml |
| 4. | Copperoxide + Fusilasole + | 90 g + 20 ml + 5 L |
| | G. africana extract | |
| 5. | Boric acid/citrus oil + G. africana | 250 ml + 5 L |
| | extract | |

APPLICATION DATE: 15 Dec. 2009

| | | |
|---|---|---|
| 1. | Control (Untreated) | |
| 2. | Mancozeb + Sulphur | 200 g + 300 g |
| 3. | Boric acid/citrus oil | 500 ml |
| 4. | Mancozeb + Sulphur + G. africana | 100 g + 150 g + 5 L |
| | extract | |
| 5. | Boric acid/citrus oil + G. africana | 250 ml + 5 L |
| | extract | |

Plants were sprayed using a 20 L backpack sprayer in accordance with the application regimen indicated below.

| | CROP STAGE | | | | |
|---|---|---|---|---|---|
| | 50 cm shoot | Flower- | Flower- | Pea | Past pea |
| | length | ing | ing | size | size |
| APPLICATION | 20 Oct. | 30 Oct. | 16 Nov. | 26 Nov. | 15 Dec. |
| DATE | 2009 | 2009 | 2009 | 2009 | 2009 |
| BEGIN TIME | 11 H 40 | 17 H 00 | 7 H 30 | 13 H 00 | 9 H 00 |
| END TIME | 12 H 40 | 18 H 00 | 8 H 45 | 14 H 00 | 10 H 30 |

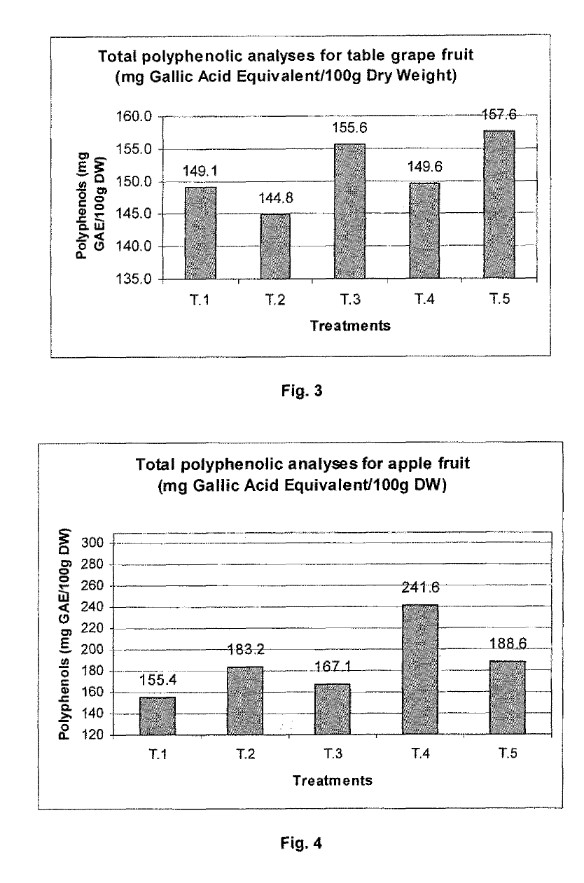

FIG. 3 shows that application to grape plants of a composition comprising a full-dosage fungicide treatment (T2) reduces the level of total polyphenolics relative to the control, but that treatment of the plants with a composition comprising half-dosage of fungicide and G. africana extract composition (T4) is able to increase the level of total polyphenolics. Furthermore, although the total polyphenolics level for treatment of the plants with a full-dosage of Boric acid/citrus oil (T3) was higher than the control, this level could be increased further by administration of a composition comprising a half-dosage of Boric acid/Citrus oil and G. africana extract (T5). All five treatments were replicated four times.

### Example 3

A field trial was laid out to test the efficacy of fungicide products (Boric acid/citrus oil, Siprodinit, Mancozeb, Difeno/penconazole and Flusilazole) in combination with G. africana extract on apples (cultivar—Golden Delicious) on a farm in Villiersdorp in the Western Cape region. The G. africana extract was at a concentration of 20% (w/v).

| | |
|---|---|
| PRODUCTS | VOLUME/100 L |

APPLICATION DATE: 19 Oct. 2009

| | | |
|---|---|---|
| 1. | Control (Untreated) | |
| 2. | Mancozeb + Siprodinil | 150 g + 30 g |
| 3. | Boric acid/citrus oil | 500 ml |
| 4. | Mancozeb + Siprodinil + G. africana | 75 g + 15 g + 5 L |
| | extract | |
| 5. | Boric acid/citrus oil + G. africana | 250 ml + 5 L |
| | extract | |

APPLICATION DATE: 29 Oct. 2009

| | | |
|---|---|---|
| 1. | Control (Untreated) | |
| 2. | Mancozeb + Difeno/penconazole | 150 g + 10 ml |
| 3. | Boric acid/citrus oil + Flusilazole | 500 ml + 24 ml |
| 4. | Mancozeb + Difeno/penconazole + | 75 g + 5 ml + 5 L |
| | G. africana extract | |
| 5. | Boric acid/citrus oil + Flusilazole + | 250 ml + 12 ml + 5 L |
| | G. africana extract | |

APPLICATION DATE: 16 Nov. 2009

| | | |
|---|---|---|
| 1. | Control (Untreated) | |
| 2. | Mancozeb + Flusilazole | 150 g + 24 ml |
| 3. | Boric acid/citrus oil + Flusilazole | 500 ml + 24 ml |
| 4. | Mancozeb + Flusilazole + G. africana | 75 g + 12 ml + 5 L |
| | extract | |
| 5. | Boric acid/citrus oil + Flusilazole + | 250 ml + 12 ml + 5 L |
| | G. africana extract | |

APPLICATION DATE: 26 Nov. 2009

| | | |
|---|---|---|
| 1. | Control (Untreated) | |
| 2. | Mancozeb + Flusilazole | 150 g + 24 ml |
| 3. | Boric acid/citrus oil + Flusilazole | 500 ml + 24 ml |
| 4. | Mancozeb + Flusilazole + G. africana | 75 g + 12 ml + 5 L |
| | extract | |
| 5. | Boric acid/citrus oil + Flusilazole + | 250 ml + 12 ml + 5 L |
| | G. africana extract | |

APPLICATION DATE: 14 Dec. 2009

| | | |
|---|---|---|
| 1. | Control (Untreated) | |
| 2. | Mancozeb + Difeno/penconazole | 150 g + 10 ml |
| 3. | Boric acid/citrus oil + | 500 ml + 10 ml |
| | Difeno/penconazole | |
| 4. | Mancozeb + Difeno/penconazole + | 75 g + 5 ml + 10 L |
| | G. africana extract | |
| 5. | Boric acid/citrus oil + | 250 ml + 5 ml + 5 L |
| | Difeno/penconazole + G. africana | |
| | extract | |

APPLICATION DATE: 29 Dec. 2009

| | | |
|---|---|---|
| 1. | Control (Untreated) | |
| 2. | Mancozeb + Difeno/penconazole | 150 g + 10 ml |
| 3. | Boric acid/citrus oil + | 500 ml + 5 ml |
| | Difeno/penconazole | |
| 4. | Mancozeb + Difeno/penconazole + | 75 g + 5 ml + 10 L |
| | G. africana extract | |
| 5. | Boric acid/citrus oil + | 250 ml + 5 ml + 5 L |
| | Difeno/penconazote + G. africana | |
| | extract | |

Plants were sprayed using a 20 L backpack sprayer in accordance with the application regimen indicated below.

| | APPLICATION DATE | | | | |
|---|---|---|---|---|---|
| | 19 Oct. | 29 Oct. | 16 Nov. | 26 Nov. | 14 Dec. |
| | 2009 | 2009 | 2009 | 2009 | 2009 |
| BEGIN TIME | 15 H 00 | 16 H 00 | 13 H 45 | 16 H 30 | 17 H 00 |
| END TIME | 16 H 00 | 17 H 30 | 15 H 45 | 18 H 00 | 18 H 45 |

FIG. 4 shows that application to apple plants of a composition comprising a full-dosage fungicide treatment (T2) or Boric acid/citrus oil (T3) may have an increased level of total polyphenolics relative to the control, but that treatment of the plants with a composition comprising half-dosage of fungicide or Boric acid/citrus oil and G. africana extract (T4 and T5) is able to increase the level of total polyphenolics even further.

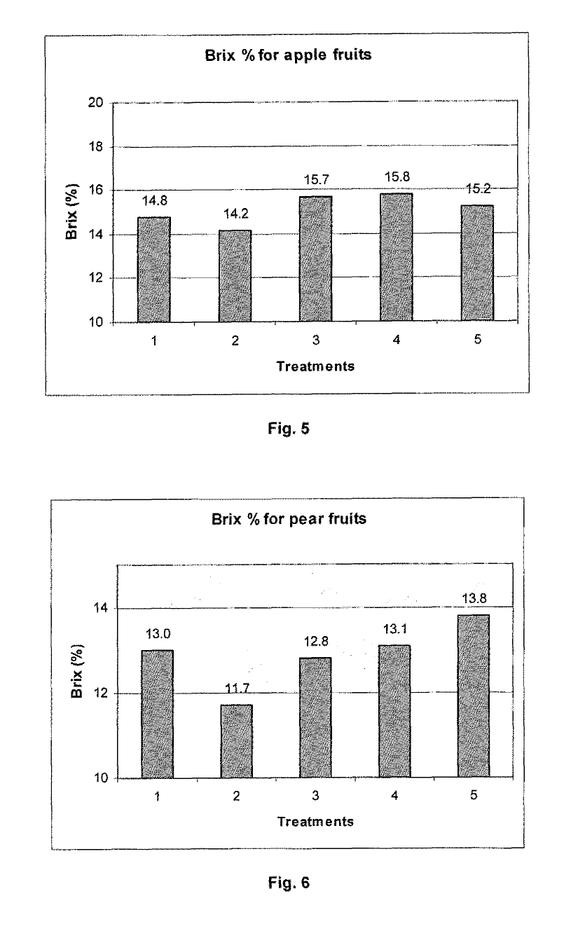

The percentage Brix was also determined for the apple fruits treated according to the previous regime. FIG. 5 shows that the full-dosage fungicide treatment (T2) decreases the level of TSS (Brix %) compared to the control fruits, whereas a full-dosage fungicide composition and G. africana extract (T4) is able to increase the level of TSS. The G. africana extract in combination with the fungicide therefore seems to reverse the negative effect of the fungicide treatment on TSS production in apples.

### Example 5

A field trial was laid out to test the efficacy of fungicide products (Kresoxim-methyl, Mancozeb and Triazole) in combination with G. africana extract on pears (cultivar—Bon Chretien) on a farm in Stellenbosch in the Western Cape region. The G. africana extract was at a concentration of 20% (w/v).

| | |
|---|---|
| PRODUCTS | VOLUME/100 L |

APPLICATION DATE: 17 Sep. 2008

| | | |
|---|---|---|
| 1. | Control (Untreated) | |
| 2. | Mancozeb + Kresoxim-methyl | 150 g + 10 g |
| 3. | Mancozeb + Kresoxim-methyl + | 75 g + 5 g + 2.5 L |
| | G. africana | |
| 4. | Mancozeb + Kresoxim-methyl + | 75 g + 5 g + 5.0 L |
| | G. africana | |
| 5. | Mancozeb + Kresoxim-methyl + | 150 g + 10 g + 1.25 L |
| | G. africana | |

APPLICATION DATE: 17 Sep. 2008

| | | |
|---|---|---|
| 1. | Control (Untreated) | |
| 2. | Mancozeb + Kresoxim-methyl | 150 g + 10 g |
| 3. | Mancozeb + Kresoxim-methyl + | 75 g + 5 g + 2.5 L |
| | G. africana | |
| 4. | Mancozeb + Kresoxim-methyl + | 75 g + 5 g + 5.0 L |
| | G. africana | |
| 5. | Mancozeb + Kresoxim-methyl + | 150 g + 10 g + 1.25 L |
| | G. africana | |

APPLICATION DATE: 4 Oct. 2008

| | | |
|---|---|---|
| 1. | Control (Untreated) | |
| 2. | Mancozeb + Kresoxim-methyl | 150 g + 10 g |
| 3. | Mancozeb + Kresoxim-methyl + | 75 g + 5 g + 2.5 L |
| | G. africana | |
| 4. | Mancozeb + Kresoxim-methyl + | 75 g + 5 g + 5.0 L |
| | G. africana | |
| 5. | Mancozeb + Kresoxim-methyl + | 150 g + 10 g + 1.25 L |
| | G. africana | |

APPLICATION DATE: 14 Oct. 2008

| | | |
|---|---|---|
| 1. | Control (Untreated) | |
| 2. | Mancozeb + Triazole | 150 g + 10 ml |
| 3. | Mancozeb + Triazole + G. africana | 75 g + 5 ml + 2.5 L |
| 4. | Mancozeb + Triazole + G. africana | 75 g + 5 ml + 5.0 L |
| 5. | Mancozeb + Triazole + G. africana | 150 g + 10 ml + 1.25 L |

APPLICATION DATE: 30 Oct. 2008

| | | |
|---|---|---|
| 1. | Control (Untreated) | |
| 2. | Mancozeb + Kresoxim-methyl | 150 g + 10 g |
| 3. | Mancozeb + Kresoxim-methyl + | 75 g + 5 g + 2.5 L |
| | G. africana | |
| 4. | Mancozeb + Kresoxim-methyl + | 75 g + 5 g + 5.0 L |
| | G. africana | |
| 5. | Mancozeb + Kresoxim-methyl + | 150 g + 10 g + 1.25 L |
| | G. africana | |

APPLICATION DATE: 14 Nov. 2008

| | | |
|---|---|---|
| 1. | Control (Untreated) | |
| 2. | Mancozeb + Kresoxim-methyl | 150 g + 10 g |
| 3. | Mancozeb + Kresoxim-methyl + | 75 g + 5 g + 2.5 L |
| | G. africana | |
| 4. | Mancozeb + Kresoxim-methyl + | 75 g + 5 g + 5.0 L |
| | G. africana | |
| 5. | Mancozeb + Kresoxim-methyl + | 150 g + 10 g + 1.25 L |
| | G. africana | |

APPLICATION DATE: 28 Nov. 2008

| | | |
|---|---|---|
| 1. | Control (Untreated) | |
| 2. | Mancozeb | 150 g |
| 3. | Mancozeb + G. africana | 75 g + 2.5 L |
| 4. | Mancozeb + G. africana | 75 g + 5.0 L |
| 5. | Mancozeb + G. africana | 150 g + 1.25 L |

APPLICATION DATE: 10 Dec. 2008

| | | |
|---|---|---|
| 1. | Control (Untreated) | |
| 2. | Mancozeb | 150 g |
| 3. | Mancozeb + G. africana | 75 g + 2.5 L |
| 4. | Mancozeb + G. africana | 75 g + 5.0 L |
| 5. | Mancozeb + G. africana | 150 g + 1.25 L |

APPLICATION DATE: 23 Dec. 2008

| | | |
|---|---|---|
| 1. | Control (Untreated) | |
| 2. | Mancozeb | 150 g |
| 3. | Mancozeb + G. africana | 75 g + 2.5 L |
| 4. | Mancozeb + G. africana | 75 g + 5.0 L |
| 5. | Mancozeb + G. africana | 150 g + 1.25 L |

Plants were sprayed using a 20 L backpack sprayer in accordance with the application regimen indicated below.

| | Crop stage/Spray interval | | | | |
|---|---|---|---|---|---|
| | | 7 days | | 10 days | 26 days |
| | | after | 75% petal | after petal | after petal |
| | Bloom | bloom | fall | fall | fall |
| Application date | 17 Sep. | 25 Sep. | 4 Oct. | 14 Oct. | 30 Oct. |
| (no) | 2008 | 2008 | 2008 | 2008 | 2008 |
| | (1) | (2) | (3) | (4) | (5) |
| Begin time | 14 h 3O | 7 h 30 | 7 h 45 | 7 h 45 | 7 h 45 |
| End time | 16 h 15 | 10 h 00 | 9 h 45 | 10 h 00 | 10 h 00 |

| | Crop stage/Spray interval | | | |
|---|---|---|---|---|
| | 41 days | 55 days | 67 days | 80 days |
| | after petal | after petal | after petal | after petal |
| | fall | fall | fall | fall |
| Application date | 14 Nov. | 28 Nov. | 10 Dec. | 23 Dec. |
| (no) | 2008 | 2008 | 2008 | 2008 |
| | (6) | (7) | (8) | (9) |
| Begin time | 7 h 30 | 7 h 30 | 7 h 45 | 7 h 45 |
| End time | 10 h 30 | 10 h 30 | 9 h 45 | 9 h 30 |

FIG. 6 shows that the full-dosage fungicide treatment (T2) decreases the level of TSS (Brix %) compared to the control fruits, whereas a full-dosage fungicide composition and G. africana extract at 0.25% (T5) or a composition comprising a half-dosage of fungicide and G. africana extract at either 0.5% or 1% (T3 and T4) is able to increase the level of TSS. The composition including the G. africana extract therefore seems to reverse the negative effect of the fungicide treatment on TSS production in pears.

### Example 6

A field trial was laid out to test the efficacy of fungicide products (Boric acid/citrus oil, Sulphur and Mancozeb) in combination with G. africana extract on peaches (cultivar—Kakamas) on two farms in Ceres in the Western Cape region. The G. africana extract was at a concentration of 20% (w/v).

| | |
|---|---|
| PRODUCTS | VOLUME/100 L |

APPLICATION DATE: 16 Oct. 2009

| | | |
|---|---|---|
| 1. | Control (Untreated) | |
| 2. | Mancozeb | 150 g |
| 3. | Boric acid/citrus oil | 500 ml |
| 4. | Mancozeb + G. africana extract. | 75 g + 5 L |
| 5. | Boric acid/citrus oil + G. africana extract. | 250 ml + 5 L |

APPLICATION DATE: 31 Oct. 2009

| | | |
|---|---|---|
| 1. | Control (Untreated) | |
| 2. | Mancozeb | 150 g |
| 3. | Boric acid/citrus oil | 500 ml |
| 4. | Mancozeb + G. africana extract. | 75 g + 5 L |
| 5. | Boric acid/citrus oil + G. africana extract | 250 ml + 5 L |

APPLICATION DATE: 17 Nov. 2009

| | | |
|---|---|---|
| 1. | Control (Untreated) | |
| 2. | Mancozeb | 150 g |
| 3. | Boric acid/citrus oil | 500 ml |
| 4. | Mancozeb + G. africana extract | 75 g + 5 L |
| 5. | Boric acid/citrus oil + G. africana extract. | 250 ml + 5 L |

APPLICATION DATE: 10 Dec. 2009

| | | |
|---|---|---|
| 1. | Control (Untreated) | |
| 2. | Sulphur | 300 g |
| 3. | Boric acid/citrus oil | 500 ml |
| 4. | Sulphur + G. africana extract | 150 g + 5 L |
| 5. | Boric acid/citrus oil + G. africana | 250 ml + 5 L |
| | extract | |

APPLICATION DATE: 23 Dec. 2009

| | | |
|---|---|---|
| 1. | Control (Untreated) | |
| 2. | Mancozeb | 150 g |
| 3. | Boric acid/citrus oil | 500 ml |
| 4. | Mancozeb + G. africana extract | 75 g + 5 L |
| 5. | Boric acid/citrus oil + G. africana | 250 ml + 5 L |
| | extract | |

APPLICATION DATE: 12 Jan. 2010

| | | |
|---|---|---|
| 1. | Control (Untreated) | |
| 2. | Sulphur | 300 g |
| 3. | Boric acid/citrus oil | 500 ml |
| 4. | Sulphur + G. africana extract | 150 g + 5 L |
| 5. | Boric acid/citrus oil + G. africana | 250 ml + 5 L |
| | extract | |

APPLICATION DATE: 25 Jan. 2010

| | | |
|---|---|---|
| 1. | Control (Untreated) | |
| 2. | Sulphur | 300 g |
| 3. | Boric acid/citrus oil | 500 ml |
| 4. | Sulphur + G. africana extract | 150 g + 5 L |
| 5. | Boric acid/citrus oil + G. africana | 250 ml + 5 L |
| | extract | |

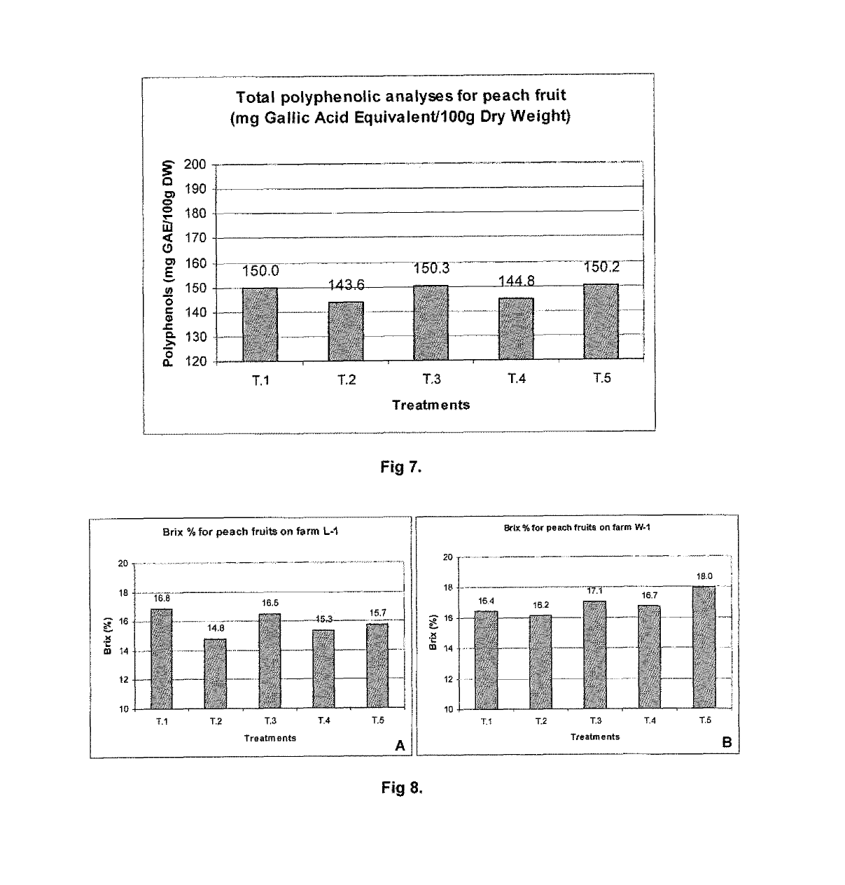

FIG. 7 shows that application to peach plants of a composition comprising a full-dosage fungicide treatment (T2) has a decreased level of total polyphenolics relative to the control but that treatment of the plants with a half-dosage of fungicide and G. africana extract (T4) is able to ameliorate the negative effect of the full dosage of fungicide.

Similarly, FIGS. 8A and 8B show that the TSS (Brix %) in the peaches is increased when a composition comprising a half-dosage of fungicide and G. africana extract (T4) is administered, compared to when a full dosage of fungicide (T2) is administered.

### Example 7

### G. africana Extract: Skin Sensitisation Test Using the Local Lymph Node Assay

This study investigated the delayed contact hypersensitivity potential of the test item, G. africana extract, using CBA/Ca mice.

A preliminary phase was conducted using 2 females, each receiving an open application of 25 μL of undiluted G. africana extract onto the dorsum of each ear. There was no evidence of systemic toxicity and there were no signs of local irritation. Consequently, in the main phase, 3 groups of 5 females were similarly treated with G. africana extract at concentrations of 25%, 50% and 100%, respectively. The vehicle was dimethylformamide and one group of 5 females received only this and acted as controls. Three days later each animal received an intravenous injection of 250 μL of phosphate buffered saline containing approximately 20 μCi of [methyl-³H] thymidine into the lateral tail vein. Approximately 5 hours later the draining Lymph nodes were collected and the incorporation of tritiated thymidine was assessed by scintillation counting.

There were no systemic signs noted in any animal during the observation period and body weight changes were considered to be acceptable for mice of this age and strain. The stimulation index (SI) values for the mice treated with the G. africana extract at concentrations of 25%, 50% or 100%, when compared with the control group, were 1.3, 0.9 and 1.3, respectively. Since there were no SI values >3, it was not possible to determine the estimated concentration of the test item required to produce a 3-fold increase in draining lymph node cell proliferation (the EC3 value).

In conclusion, open application of G. africana extract to the ears of 3 groups of mice at concentrations of 25%, 50% and 100%, respectively, did not result in a stimulation index of >3 in any group and, consequently, it is considered that the test item does not have the potential to cause sensitisation.

G. africana Extract: Assessment of Irritation Potential of the Concentrate and In-Use Dilution Using the Episkin® Test System In Vitro

Acute irritation is an inflammatory response of normal living skin to direct injury caused by the application of an irritant substance. Evaluation of skin irritation is part of the Human Health Hazard Assessment required for registration of a chemical.

G. africana extract was accepted for testing in the SkinEthic EpiSkin® in vitro irritation assay. The endpoint of the assay was the estimation of cell viability by assaying the reduction of methythiazoldiphenyl-tetrazolium bromide (MTT) to its formazan metabolite by mitochondrial reductase. Irritant materials are identified by their ability to reduce cell viability below a threshold of 50% of the negative control value,

A preliminary test was conducted to assess the ability of the test item to directly reduce MTT. G. africana extract did not interact with the MTT solution.

The irritation potential of G. africana extract was assessed by applying the concentrated extract and the in-use dilution (concentrate diluted to 1% (v/v) in sterile ultra-pure water) onto the surface of three viable EpiSkin® reconstructed human epidermis units for ca 15 min. The test item was then washed from the surface of the EpiSkin® and the units returned to the incubator for a recovery period of ca 42 h. After the recovery period, the skin units were transferred to assay medium containing MIT (0.3 mg/mL) and returned to the incubator for ca 3 h. Biopsies of the EpiSkin® membranes were then removed and added to acidic isopropanol. The formazan production was assessed by measuring absorption at 550 nm and the viability of each individual tissue calculated as a percentage of the mean negative control viability.

Exposure to G. africana extract (concentrate) resulted in an EpiSkin® viability of 84.75%±11.26% of the negative control value. Exposure to G. africana extract (in-use dilution) resulted in an EpiSkin® viability of 92.97%±14.63% of the negative control value. The positive and negative controls, conducted in parallel, were within the defined acceptance criteria and demonstrated the efficacy of the test system.

In conclusion, G. africana extract (concentrate) and G. africana extract (in-use dilution) are non-irritant (no label) when tested within the EpiSkin® in vitro irritation assay.

G. africana Extract: Acute Dermal Toxicity (Limit) Test in Rats

This study investigated the dermal toxicity potential of the test item, G. africana extract, after a single administration to Sprague-Dawley rats.

Five males and 5 females received G. africana extract at a dosage of 2000 mg/kg. The test Item was administered, as supplied, onto the dorsal trunk and covered with an occlusive patch for 24 hours. The dose volume of 2.3 mL/kg was based upon the relative density of the test item, 0.883 g/mL. The volume administered to each rat was calculated from individual animal body weights on the day of dosing. Animals were observed for adverse clinical signs until the end of the observation period on Day 15. Body weights were recorded weekly and all animals were subjected to a necropsy examination.

There were no systemic signs of toxicity noted in any animal at any observation timepoint. Body weight gain was considered to be acceptable for rats of this age and strain. There were no findings at necropsy that were considered to be related to treatment.

Under the conditions of the study, the median lethal dermal dosage (LD50) for G. africana extract in Sprague-Dawley rats was considered to exceed 2000 mg/kg.

G. africana Extract: Acute Oral Toxicity (Acute Toxic Class) Test in Rats

This study investigated the acute oral toxicity of the test item, G. africana extract, after a single administration to Sprague-Dawley rats.

G. africana extract was administered, as supplied, to one group of 3 females at 300 mg/kg and to 2 groups of 3 females at 2000 mg/kg. The administered volume was calculated from each individual animal's body weight on the day of dosing and the relative density of the test item, 0.883 g/mL. Animals were observed for signs of reaction to treatment until Day 15. Body weights were recorded weekly and all animals were subjected to a gross necropsy.

There were no unscheduled deaths and no adverse signs of reaction to treatment were recorded at either dosage. Body weight gain was considered to be acceptable for rats of this age and strain and no macroscopic abnormalities were recorded at necropsy.

In conclusion, under the conditions of the study the median lethal oral dosage (LD50) of G. africana extract in Sprague-Dawley rats was considered to exceed 2000 mg/kg.

### REFERENCES

Dillard C J, German J B. Phytochemicals: Nutraceuticals and human health. Journal of the Science of Food and Agriculture 2000; 80:1744-1756
Huang, M-T, et al. 1991. Phenolic compounds in food and their effects on health IL Antioxidants and cancer prevention. Fourth chemical congress of North America. 202^{nd} National Meeting of The American Society. New York.
Singleton V. L., Orthofer, R. & Lamuela-Ravantos, R. M. 1999. Analyses of total phenols and other oxidation substrates and antioxidants by means of the Folin-Ciolcalteu reagent. Methods in Enzymology, 299:152-178
Rice-Evans C, Packer L, Flavonoids in Health and Diseases. New York: Marcel Decker 1998.

1. A method of increasing the polyphenolic compound content and/or the total soluble solids content, in a plant, the method comprising administering to the plant, an extract of Galenia africana.

2. The method of claim 1, wherein the Galenia africana extract is administered in an amount of about 0.25% to about 2% (v/v).

3. The method according to claim 1, wherein the Galenia africana extract is administered at a concentration of 20% (w/v).

4. The method according to claim 1, wherein the polyphenolic compound is a cholesterol-lowering agent, an antioxidant, a radical scavenger, an anti-inflammatory agent, a carbohydrate metabolism promoter, an immune system modulator, an anti-ulcer agent, an oestrogen antagonist or an agent that modulates the metabolism of a xenobiotic.

5. The method according to claim 4, wherein the polyphenolic compound is a flavone, a hydroxycinnamic acid, a flavonol, a hydroxybenzoic acid, a flavanol, a chatechin, or a flavanone.

6. The method according to claim 5, wherein the polyphenolic compound is selected from naringenin, chlorogenic acid, 7-hydroxyflavone, 5.7-dihydroxyflavonone (Pinocembrin).

7. The method according to claim 1, wherein the method further comprises administering a fungicide to the plant.

8. The method according to claim 7, wherein the fungicide is administered before, after or simultaneously with the administration of the Galenia africana extract.

9. The method according to claim 7, wherein the fungicide is selected from the group consisting of Sodium Bicarbonate, Boric acid/citrus oil, Mancozeb, Sulphur, Penconazole, Fusilasole, Copperoxide, Kresoxim methyl (or Strobulirin) and Triazole.

10. The method according to claim 1, wherein the plant is a food plant, including a tomato, apple, pear, peach or grape plant.

11. A plant, or a leaf, tuber or fruit thereof with increased polyphenolic compound content and/or increased total soluble solids content relative to an untreated plant, wherein the plant, or leaf, tuber or fruit thereof with increased polyphenolic compound content and/or increased total soluble solids content has been treated with an extract of Galenia africana.

12. A plant, or a leaf, tuber or fruit thereof with increased polyphenolic compound content and/or increased total soluble solids content wherein the plant, or leaf, tuber or fruit thereof has been, or is treated with a fungicide and an extract of Galenia africana, compared to a plant, or leaf, tuber or fruit thereof treated with a fungicide alone.

13. A kit for increasing the polyphenolic compound content in a plant, comprising an effective dose of an extract of Galenia africana and instructions for use.

14. Use of a Galenia africana extract for increasing the polyphenolic compound content and/or the total soluble solids content in a plant.
